(19) United States
(12) Patent Application Publication
(10) Pub. No.: US 2014/0348134 A1
(43) Pub. Date: Nov. 27, 2014

(54) SYSTEM AND PROTOCOLS FOR INTER-MOBILITY ACCESS GATEWAY TUNNELING FOR FAST HANDOFF TRANSITION

(71) Applicant: Rockstar Consortium US LP, Plano, TX (US)

(72) Inventors: Ahmad MUHANNA, Richardson, TX (US); Eric PARSONS, Stittsville (CA); Marvin BIENN, Dallas, TX (US)

(21) Appl. No.: 14/457,867

(22) Filed: Aug. 12, 2014

Related U.S. Application Data
(63) Continuation of application No. 13/261,253, filed on Apr. 5, 2012.
(60) Provisional application No. 61/248,943, filed on Oct. 6, 2009.
(60) Provisional application No. 61/251,390, filed on Oct. 14, 2009.

(51) Int. Cl. H04W 36/08; H04W 72/04

(52) U.S. Cl. CPC H04W 36/08; H04W 72/042
USPC 370/331

(57) ABSTRACT

A system and method for transitioning connectivity of a mobile node between mobility access gateways on a communication system using inter-MAG tunneling protocols for a fast handoff. The protocols can use pre-configured or dynamic protocols on the IP-Layer or another layer on the protocol stack. For bi-directional tunneling, the mobility session context information for the mobile node is transferred to the next MAG in advance of the fast handoff. For uni-directional tunnel, a uni-directional tunneling mechanism simplifies the logic of tunnel negotiation and setup during the fast handoff with the creation of a temporary forwarding state where all up-link traffic can be sent from the mobile node to the home network through the nMAG, but the down-link traffic from the home network is sent to the pMAG for forwarding to the nMAG and then the mobile node.

### RELATED APPLICATION DATA

This application is a continuation of U.S. patent application Ser. No. 13/261,253, entitled “SYSTEM AND PROTOCOLS FOR INTER-MOBILITY ACCESS GATEWAY TUNNELING FOR FAST HANDOFF TRANSITION”, having a National Phase Entry date of Apr. 5, 2012, for PCT Application Serial No.: PCT/US2010/051527, filed Oct. 5, 2010, and claims the benefit of U.S. Provisional Patent Application Ser. No. 61/251,390, filed Oct. 14, 2009 and Provisional Patent Application Ser. No. 61/248,943 filed Oct. 6, 2009, the entire contents of all of which are hereby incorporated herein by reference.

### TECHNICAL FIELD OF THE INVENTION

A system and method for transitioning connectivity of a mobile node between mobility access gateways (MAG) on a communication system using an inter-MAG tunneling protocols for a fast handoff.

### BACKGROUND OF THE INVENTION

IP-based mobile systems provide for communication between at least one mobile node and a wireless communication network. The term “mobile node” includes a mobile communication unit (e.g., mobile terminal, “smart phones”, nomadic devices such as laptop PCs with wireless connectivity, as described in greater detail below). Among other elements, the wireless communication system includes a home network and a foreign network. The mobile node may change its point of attachment to the Internet through these networks, but the mobile node will always be associated with a single home network for IP addressing purposes. The home network includes a home agent and the foreign network includes a foreign agent—both of which control the routing of information packets into and out of their network.

The mobile node, home agent and foreign agent may be called different names depending on the nomenclature used on any particular network configuration or communication system. For instance, a “mobile node” encompasses PC's having cabled (e.g., telephone line (“twisted pair”), Ethernet cable, optical cable, and so on) connectivity to the wireless network, as well as wireless connectivity directly to the cellular network, as can be experienced by various makes and models of mobile terminals (“cell phones”) having various features and functionality, such as Internet access, e-mail, messaging services, and the like. Mobile nodes are sometimes called a user equipment, mobile unit, mobile terminal, mobile device, or similar names depending on the nomenclature adopted by particular system providers. Generally, there is also a correspondence node, which may be mobile or fixed, that may be located on the network for communicating with the mobile node.

A home agent may also be referred to as a Local Mobility Anchor, Home Mobility Manager, Home Location Register, and a foreign agent may be referred to as a Mobile Access Gateway, Serving Mobility Manager, Visited Location Register, and Visiting Serving Entity. The terms mobile node, home agent and foreign agent are not meant to be restrictively defined, but could include other mobile communication units or supervisory routing devices located on the home or foreign networks. Foreign networks can also be called serving networks.

### Registering the Mobile Node

Foreign agents and home agents periodically broadcast an agent advertisement to all nodes on the local network associated with that agent. An agent advertisement is a message from the agent on a network that may be issued under the Mobile IP protocol (RFC 2002) or any other type of communications protocol. This advertisement should include information that is required to uniquely identify a mobility agent (e.g. a home agent, a foreign agent, etc.) to a mobile node. Mobile nodes examine the agent advertisement and determine whether they are connected to the home network or a foreign network.

The mobile node will always be associated with its home network and sub-network for IP addressing purposes and will have information routed to it by routers located on the home and foreign network. If the mobile node is located on its home network, information packets will be routed to the mobile node according to the standard addressing and routing scheme. If the mobile node is visiting a foreign network, however, the mobile node obtains appropriate information from the agent advertisement, and transmits a registration request message (sometimes called a binding update request) to its home agent through the foreign agent. The registration request message will include a care-of address for the mobile node. A registration reply message (also called a binding update acknowledge message) may be sent to the mobile node by the home agent to confirm that the registration process has been successfully completed.

The mobile node keeps the home agent informed as to its location on foreign networks by registering a “care-of address” with the home agent. The registered care-of address identifies the foreign network where the mobile node is located, and the home agent uses this registered care-of address to forward information packets to the foreign network for subsequent transfer onto the mobile node. If the home agent receives an information packet addressed to the mobile node while the mobile node is located on a foreign network, the home agent will transmit the information packet to the mobile node's current location on the foreign network using the applicable care-of address. That is, this information packet containing the care-of address will then be forwarded and routed to the mobile node on the foreign network by a router on the foreign network according to the care-of address.

When mobile nodes move from one foreign network to another foreign network, problems are sometimes encountered with the registration of the care of addressing with the home agent or local mobility anchor. Further, multiple interfaces may be supported on a single or multiple foreign networks, which can include the different communication access types 802.11d, 802.11g, HRPD, WiFi, WiMax, CDMA, GSM, UMTS or LTE. Problems can be encountered when the mobile node becomes coupled to different access types on a single or multiple networks. Lastly, problems arise with the “hand-off” procedures regarding the optimization of the resource usage on the network by the local mobility anchor and the mobility agent gateway, including the problems associated with the determination by the mobility agent gateway (or foreign agent) to reject resource revocation request and the determination of which network resources to maintain, revoke or temporarily hold for predetermined periods of time.

Notably, there is a need for a signaling protocol between the new or next MAG that will be serving the mobile node after the fast “hand-off” routine and the prior or previous MAG that was servicing the mobile node before the fast “hand-off” routine. There is a need to allow the fast “hand-off” routine to be conducted to allow the active mobile node transitioning to the next MAG to continue to send and receive packet data without delay, packet loss or interruption, especially for time sensitive applications like VoIP.

Thus, it is a primary objective of this invention to provide addressing support for a mobile node where there is a “fast handover” to a new foreign network (nMAG) using a new signaling protocol. Further, it is primary objective of this invention to provide, in advance of the transfer of the mobile node, sufficient context, type of communication, and other information between the new or next MAG that will be serving the mobile node after the fast “hand-off” routine and the prior or previous MAG that was servicing the mobile node before the fast “hand-off” routine to avoid delays, interruptions, and packet losses.

### SUMMARY OF THE INVENTION

The present invention achieves these objectives and solves these problems by providing a system and method for transitioning connectivity of a mobile node between mobility access gateways on a communication system using an inter-MAG tunneling protocols for a fast handoff. The protocols can use pre-configured or dynamic protocols on the IP-Layer or another layer on the protocol stack.

In a bi-directional tunneling mechanism, the protocol and system supports the transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity. This solution supports bi-directional traffic, including up-link and down-link communications transfers, between the mobile node and the home network, or LMA.

In a uni-directional tunneling mechanism, the protocol and system supports a uni-directional tunneling mechanism that simplifies the logic of tunnel negotiation and setup during the fast handoff with the creation of a temporary forwarding state where all up-link traffic can be sent from the mobile node to the home network through the nMAG but the down-link traffic from the home network is sent to the pMAG for forwarding to the nMAG and then the mobile node. As an alternative, the protocol and system can also support a layer 2 uni-directional downlink tunnel which is not impacted by the IP-layer and can be established between base stations.

The present invention can be implemented using a new protocol application or modified messages from prior registration applications.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 is a mobile IP-based communication system as used in the present invention using the bi-directional tunneling mechanism;

FIG. 2 is a message flow showing a pre-configured bi-directional tunneling mechanism;

FIG. 3 is a message flow showing an advanced pre-configured bi-directional tunneling mechanism;

FIG. 4 is a message flow showing an dynamic bi-directional tunneling mechanism;

FIG. 5 is a mobile IP-based communication system as used in the present invention using the uni-directional tunneling mechanism;

FIG. 6 is a message flow showing the uni-directional tunneling mechanism;

FIG. 7 is a message flow showing the layer-2 uni-directional tunneling mechanism.

The objects and features of the invention will become more readily understood from the following detailed description and appended claims when read in conjunction with the accompanying drawings in which like numerals represent like elements.

### DETAILED DESCRIPTION OF THE PREFERRED EMBODIMENTS

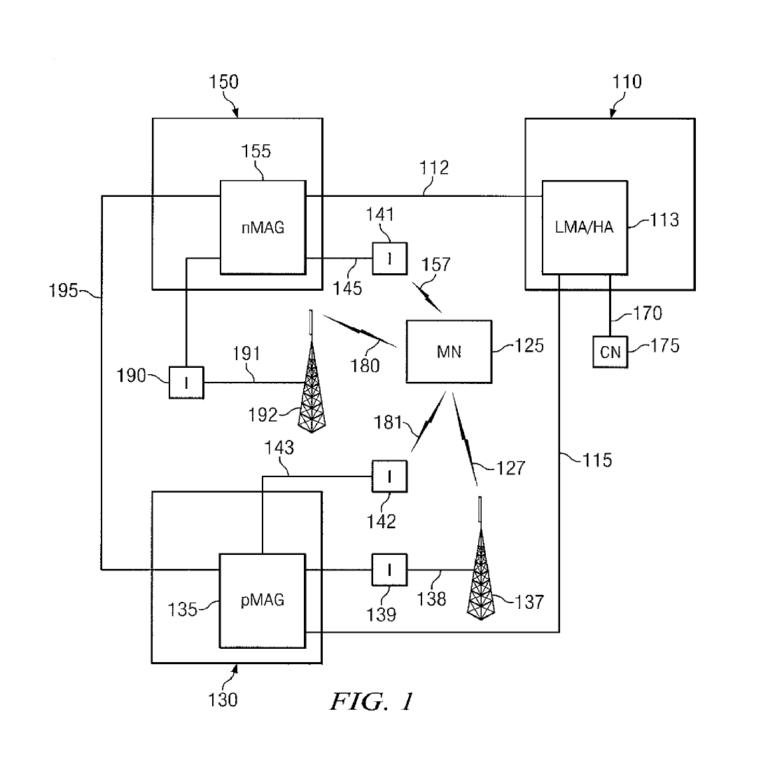

In FIG. 1, the overall architecture of the IP-based mobile system is shown with a mobile mode 125, a home network 110 and foreign networks 130 and 150, respectively. As shown in FIG. 1, the home network 110 has a home agent or local mobility anchor (LMA/HA) 113. The local mobility anchor (LMA/HA) 113 is coupled to a correspondent node 175 via communication link 170, the next mobility agent gateway (nMAG) 155 on a second foreign network 150 by communication link 112, and the prior mobility agent gateway (pMAG) 135 on a first foreign network 130 by communication link 115. The pMAG may also be located on the home network.

Prior to handoff of the mobile node connectivity to the system, the prior mobility agent gateway (pMAG) 135 on a first foreign network 130 is coupled to the mobile node 125 through the radio access system comprised of the base station transceiver 139 coupled to the antenna/transmitter 137 and a wireless communication link 127. The prior mobility agent gateway (pMAG) 135 can also be coupled the mobile node 125 using a second communication access type, such as WiMax or WiFi, which is supported by the interface 142 coupled to the pMAG 135 via connection 143 and coupled to the mobile node 125 via a wireless communication link 181.

After handoff of the mobile node connectivity to the system, the next mobility agent gateway (nMAG) 155 on a second foreign network 150 is coupled to the mobile node 125 through the radio access system comprised of the base station transceiver 190 coupled to the antenna/transmitter 192 and a wireless communication link 180. The next mobility agent gateway (nMAG) 155 can also be coupled the mobile node 125 using a second communication access type, such as WiMax or WiFi, which is supported by the interface 141 coupled to the nMAG 155 via connection 145 and coupled to the mobile node 125 via a wireless communication link 157.

Mobile node 125 is shown electronically coupled to the foreign networks 150 and 130 via the wireless communication links 127, 157, 180 and 181, respectively. The mobile node 125, however, can communicate with any transceiver or access network coupled to the foreign networks. That is, communications links 127 and 157 are radio transmitted links, but these links can be composed of any connection between two or more nodes on a network or users on networks or administrative domains.

The terms Local Mobility Anchor, home agent, and foreign agent may be as defined in the Mobile IP Protocol (RFC 2002), but these agents are not restricted to a single protocol or system. In fact, the term home agent, as used in this application, can refer to a home mobility manager, home location register, home serving entity, or any other agent at a home network 110 having the responsibility to manage mobility-related functionality for a mobile node 125. Likewise, the term mobility agent gateway, as used in this application, can refer to a foreign agent, serving mobility manager, visited location register, visiting serving entity, serving gateway, or any other agent on a foreign network having the responsibility to manage mobility-related functionality for a mobile node 125.

In the mobile IP communications system shown in FIG. 1, the mobile node 125 is identified by a permanent IP address. While the mobile node 125 is coupled to its home network 110, the mobile node 125 receives information packets like any other fixed node on the home network 110. When mobile, the mobile node 125 can also locate itself on foreign network, such as network 130 or 150. When located on foreign network 130 or 150, the home network 110 sends data communications to the mobile node 125 by “tunneling” the communications to the foreign network 130 or 150.

The mobile node 125 keeps the local mobility anchor 113 informed of its current location, or foreign network association, by registering a care-of address with the local mobility anchor 113. Essentially, the care-of address represents the foreign network where the mobile node 125 is currently located. If the local mobility anchor 113 receives an information packet addressed to the mobile node 125 while the mobile node 125 is located on a foreign network 130, the local mobility anchor 113 will “tunnel” the information packet to foreign network 130 for subsequent transmission to mobile node 125. If the local mobility anchor 113 receives an information packet addressed to the mobile node 125 while the mobile node 125 is located on a foreign network 150, the local mobility anchor 113 will “tunnel” the information packet to foreign network 150 for subsequent transmission to mobile node 125. The foreign agent 135 or 155 receives information packets for the mobile node 125 (depending on the mobile node's foreign network connection) after the information packets have been forwarded to the foreign agent 135 by the local mobility anchor 113. These are called “down-link” communications.

The foreign agent 135 serves as a default router for out-going information packets generated by the mobile node 125 while connected to the foreign network 130. The mobile node 125 sends out-going transmissions to the foreign agent 135 or 155 (depending on the mobile node's foreign network connection), and the foreign agent sends the communications onto the local mobility anchor 113 for transmission onto other nodes, such as the correspondent node 175. These are called “up-link” communications.

The LMA/HA 113 can be coupled to a larger service network, such as a 3GPP2 network. The foreign agent 135 or 155 (depending on the mobile node's foreign network connection) participates in informing the local mobility anchor 113 of the mobile node 125 current care-of address. Moreover, the mobile node 125 can also participate in informing the local mobility anchor 113 of its current location and requests connections to the associated foreign network. When the mobile node 125 transitions to connecting to a different access type on the foreign network or a wholly different foreign network (handover), the mobile node 125 obtains appropriate information regarding the address of the foreign network and/or the foreign agent from an agent advertisement.

Connection 195 is an inter-MAG tunnel connection in the IP-Layer between pMAG 135 and nMAG 155, where transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity. This solution supports bi-directional traffic, including up-link and down-link communications transfers, between the mobile node and the home network, or LMA.

Connection 195, the inter-MAG tunnel connection in the IP-Layer between pMAG 135 and nMAG 155, is where transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity. It should be noted that the same fast handoff protocols set forth below can be used to create and establish a tunnel between EUTRAN eHRPD components in a fast handoff protocol.

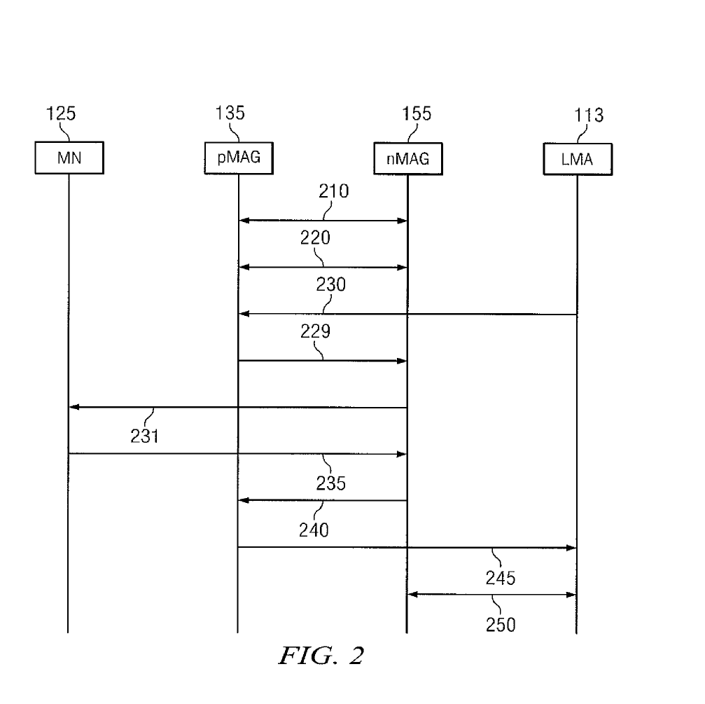

In FIG. 2, a pre-configured inter-MAG bi-directional tunnel protocol or message flow is shown with reference to the components shown in FIG. 1. In the protocol defined in FIG. 2, operators can define a single pre-configured bi-directional IP-Layer tunnel between the pMAG 135 and nMAG 155. For example, operators may define the GRE encapsulation/tunneling with Generic Routing Encapsulation (GRE) keys as the IP-Layer tunneling mechanism between the pMAG 135 and nMAG 155.

The inter-MAG tunnel is pre-configured based on GRE keys, and which may be exchanged in a specific order or through another mobility option. As shown in FIG. 2, step 210 shows a Reactive Mode exchange of GRE keys where the nMAG 155 sends a handover interface HI message to the pMAG 135, and the pMAG 135 sends a handover acknowledge HACK message back to nMAG 155, thereby exchanging the needed GRE keys and establishing the inter-MAG tunnel between the pMAG 135 and nMAG 155. Alternatively, in the Active Mode exchange of GRE keys shown in step 220, the pMAG 135 sends a handover interface HI message to the nMAG 155, and the nMAG 155 sends a handover acknowledge HACK message back to pMAG 135, thereby exchanging the needed GRE keys and establishing the inter-MAG tunnel between the pMAG 135 and nMAG 155. This exchange may be done at the beginning of each mobility session, and the GRE keys can be the same GRE keys used between the pMAG 135 and LMA 113, or the GRE keys can be specific to the inter-MAG tunnel between the pMAG 135 and nMAG 155. Keys or tunneling other than GRE keys can be used, but it needs to support bi-directional traffic.

For the protocol in FIG. 2, the down-link communications are transferred in step 230 from the LMA 113 to the pMAG 135, which transfers the down-link communications to the nMAG 155 over the inter-MAG tunnel 195 in step 229. The nMAG 155 then transfers the down-link communications to the mobile node 125 in step 232. For up-link communications, the mobile node 125 transfers communications to the nMAG 155 at step 235, which transfers the communication packets to pMAG 135 at step 240 on the inter-MAG tunnel 195. After receipt by the pMAG 135, the pMAG 135 subsequently transfers the communication packets to the LMA 113 in step 245. This protocol supports the transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity.

This solution supports bi-directional traffic, including up-link and down-link communications transfers, between the mobile node and the home network, or LMA 113 during the handoff period. After the handoff procedure is complete and the mobile node has moved completely to connectivity with nMAG 155, the nMAG 155 sends a proxy binding update PBU message 250 to the LMA 113, which updates its connection entry tables to show the new connection of the mobile node 125 with the nMAG 155 for the future direction and receipt of down-link and up-link communications, respectively, with the nMAG 155. It should be noted that this same fast handoff protocol can be used to create and establish a tunnel between EUTRAN eHRPD components in a fast handoff protocol.

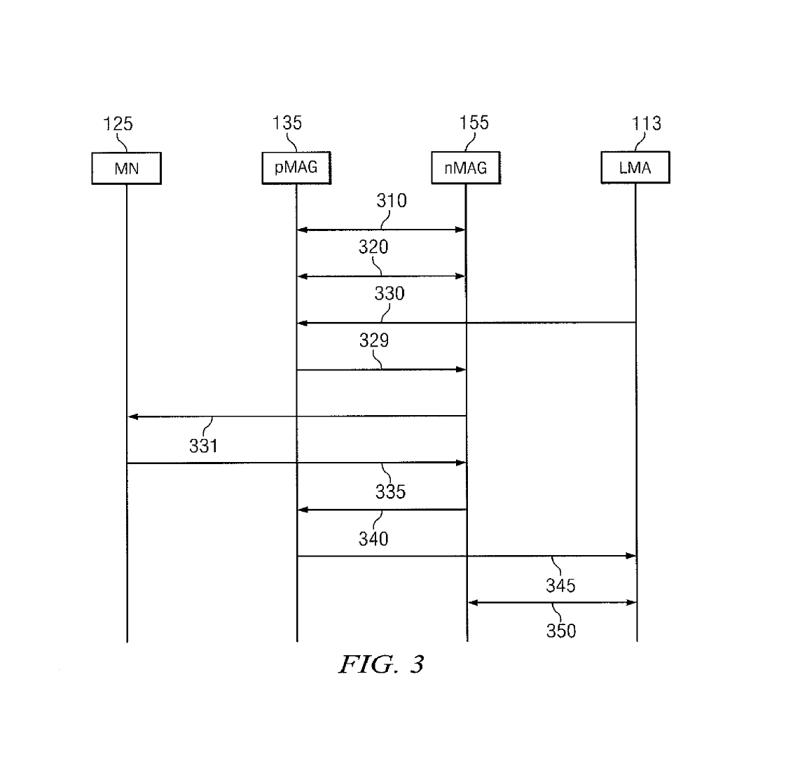

In FIG. 3, the advanced pre-configured inter-MAG bi-directional tunnel protocol or message flow is shown with reference to the components shown in FIG. 1. In the protocol defined in FIG. 3, operators can define a single pre-configured bi-directional IP-Layer tunnel between the pMAG 135 and nMAG 155. For example, operators may define the GRE encapsulation/tunneling with Generic Routing Encapsulation (GRE) keys as the IP-Layer tunneling mechanism between the pMAG 135 and nMAG 155. Because mapping functionality is used on the pMAG 135, key other than GRE can be used for the inter-MAG tunnel.

The inter-MAG tunnel is pre-configured based on GRE keys, and which may be exchanged in a specific order or through another mobility option. The pMAG 135 must have a mapping functionality that maps the mobile node mobility session downlink and uplink traffic from the tunneling mechanism on the pMAG 135 to LMA 113 connection to the pMAG 135 to nMAG 155 connection. For example, the pMAG must be able to support the mapping of down-link traffic from the UDP encapsulation to the GRE encapsulation so there is no ambiguity or confusion over the proper nMAG being used in the fast handoff transition period. If IPv4 is used, private addresses may be used for the GRE end of tunnel IP addresses. Alternatively, the end of the inter-MAG GRE tunnel can use public IPv4 addresses or IPv6-in-IPv4 User Data Protocol (UDP) with TLV where a Network Address Translation (NAT) is present between the pMAG 135 and the nMAG 155.

As shown in FIG. 3, step 310 shows a Reactive Mode exchange of GRE keys where the nMAG 155 sends a handover interface HI message to the pMAG 135, and the pMAG 135 sends a handover acknowledge HACK message back to nMAG 155, thereby exchanging the needed GRE keys and establishing the inter-MAG tunnel between the pMAG 135 and nMAG 155. Alternatively, in the Active Mode exchange of GRE keys shown in step 320, the pMAG 135 sends a handover interface HI message to the nMAG 155, and the nMAG 155 sends a handover acknowledge HACK message back to pMAG 135, thereby exchanging the needed GRE keys and establishing the inter-MAG tunnel between the pMAG 135 and nMAG 155.

This exchange may be done at the beginning of each mobility session, and the GRE keys can be the same GRE keys used between the pMAG 135 and LMA 113, or the GRE keys can be specific to the inter-MAG tunnel between the pMAG 135 and nMAG 155. Keys or tunneling other than GRE keys can be used, but it needs to support bi-directional traffic. The pMAG 135 maps out the connections for the downlink traffic from the UDP encapsulation to the GRE encapsulation so there is no ambiguity or confusion over the proper nMAG 155 connection to the mobile node 125.

For the protocol in FIG. 3, the down-link communications are transferred in step 330 from the LMA 113 to the pMAG 135, which transfers the down-link communications to the nMAG 155 over the inter-MAG tunnel 195 in step 329 using the mapping functionality. The nMAG 155 then transfers the down-link communications to the mobile node 125 in step 332. For up-link communications, the mobile node 125 transfers communications to the nMAG 155 at step 335, which transfers the communication packets to pMAG 135 at step 340 on the inter-MAG tunnel 195. After receipt by the pMAG 135, the pMAG 135 subsequently transfers the up-link communication packets to the LMA 113 in step 345.

This protocol supports the transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity. This solution supports bi-directional traffic, including up-link and down-link communications transfers, between the mobile node and the home network, or LMA 113 during the handoff period. After the handoff procedure is complete and the mobile node has moved completely to connectivity with nMAG 155, the nMAG 155 sends a proxy binding update PBU message 350 to the LMA 113, which updates its connection entry tables to show the new connection of the mobile node 125 with the nMAG 155 for the future direction and receipt of down-link and up-link communications, respectively, with the nMAG 155. It should be noted that this same fast handoff protocol can be used to create and establish a tunnel between EUTRAN eHRPD components in a fast handoff protocol.

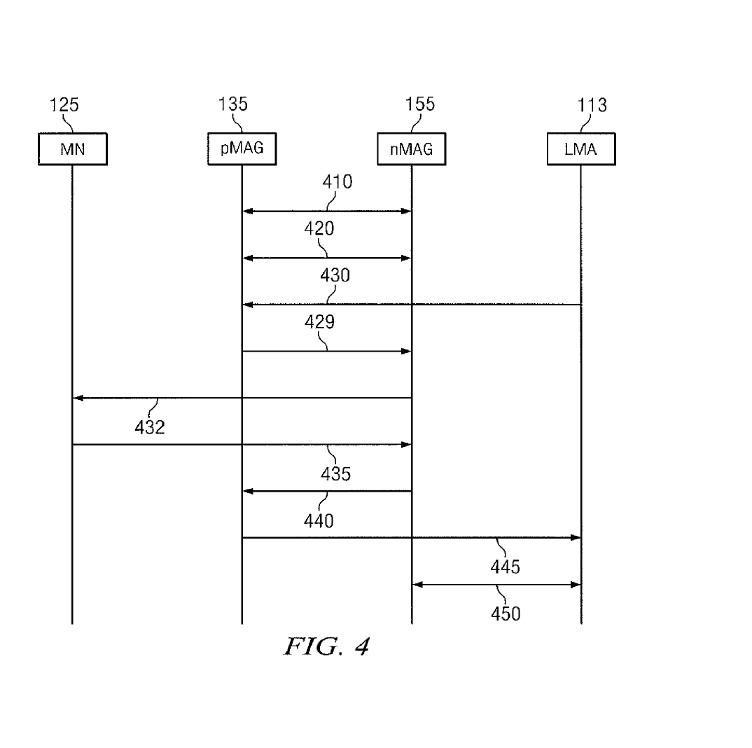

In FIG. 4, the dynamic inter-MAG bi-directional tunnel protocol or message flow is shown with reference to the components shown in FIG. 1. In the protocol defined in FIG. 4, a new tunneling type mobility option is defined on the communication system to carry information regarding the current per-mobility session tunneling mechanism between the pMAG 135 and the LMA 113 to be used in the fast handoff signaling messages. The tunneling mechanism is defined per-mobility session between the pMAG 135 and the LMA 113 as negotiated and communicated down to the nMAG 155 using fast handover signaling messages. The negotiated tunneling type is communicated from the pMAG 135 to the nMAG 155 using the fast handoff signaling and may depend on handoff mode and reactive or active modes used to create the tunnel.

The negotiated tunneling type is used to create the bi-directional IP-Layer tunnel between the pMAG 135 and nMAG 155, and the GRE encapsulation/tunneling with Generic Routing Encapsulation (GRE) keys as the IP-Layer tunneling mechanism between the pMAG 135 and nMAG 155 may be supported.

The inter-MAG tunnel option is transmitted between the pMAG 135 and the LMA 113, as used in the fast handoff signaling messages. The final tunneling type is defined in communications between the pMAG 135 and the nMAG 155. If FMIPv6 signaling messages are used, the Tunneling Type option is included as follows: (1) the pMAG 135 includes a tunneling type option in the HACK messages sent to the nMAG 155 in the reactive mode, or (2) the pMAG communicates the tunneling type option in the handover interface HI message in the active mode, or (3) the pMAG communicates the tunneling type option as part of the mobility session context transfer information.

As shown in FIG. 4, step 410 shows a Reactive Mode negotiation of the dynamic bi-directional tunnel with the nMAG 155 sending a handover interface HI message to the pMAG 135, and the pMAG 135 sends a handover acknowledge HACK message back to nMAG 155, thereby exchanging the necessary key information and establishing the inter-MAG tunnel between the pMAG 135 and nMAG 155. The nMAG 155 should include the GRE keys if it initiates the fast handover protocols (reactive mode), and if the GRE encapsulation is not required or a different tunneling mechanism is used, the pMAG 135 should acknowledge the handoff interface HI message without including the GRE key option (reactive mode). The pMAG 135 can force the GRE encapsulation with GRE keys by acknowledging the handoff interface HI message with the GRE key option included.

Alternatively, in the Active Mode exchange of GRE keys shown in step 420, the pMAG 135 sends a handover interface HI message to the nMAG 155, and the nMAG 155 sends a handover acknowledge HACK message back to pMAG 135, thereby exchanging the needed GRE keys and establishing the inter-MAG tunnel between the pMAG 135 and nMAG 155. In the active mode, the pMAG 135 includes a tunneling type option in the handoff interface HI message and all the required for that tunneling type. For example the pMAG can include the User Data Protocol (UDP) port number for UDP type tunneling as part of the tunneling type option or the mobility session context. The pMAG 135 can include the GRE Key option with the down-link GRE key included to force the GRE encapsulation with GRE keys, which may be used in the situation where the nMAG 155 found dynamically via the fast handoff signaling that there is not Network Access Translation component between the nMAG 155 and the pMAG 135. In that event, the nMAG includes a GRE key option with the uplink GRE key in a successful HACK message. Also, in the case of IPv6-in-IPv4 UDP with TLV tunneling types, the GRE key option can also be used to exchange the GRE keys for this type of tunneling to be used over the inter-MAG tunnel.

The creation of the dynamic tunnel is done on a per-mobility session basis, the necessary key and context information is exchanged between the pMAG 135 and LMA 113, and the keys and tunnels are specific to the inter-MAG tunnel between the pMAG 135 and nMAG 155. Keys or tunneling other than GRE keys can be used, but it needs to support bi-directional traffic.

For the protocol in FIG. 4, the down-link communications are transferred in step 430 from the LMA 113 to the pMAG 135, which transfers the down-link communications to the nMAG 155 over the inter-MAG tunnel 195 in step 429 using the mapping functionality. The nMAG 155 then transfers the down-link communications to the mobile node 125 in step 432. For up-link communications, the mobile node 125 transfers communications to the nMAG 155 at step 435, which transfers the communication packets to pMAG 135 at step 440 on the inter-MAG tunnel 195. After receipt by the pMAG 135, the pMAG 135 subsequently transfers the up-link communication packets to the LMA 113 in step 445.

This protocol supports the transfer of the mobility session context information for the mobile node to the next MAG in advance of the fast handoff to avoid delays and an inter-serving gateway bi-directional tunneling mechanism to allow forwarding of the mobility session traffic between new serving gateway and the prior serving gateway without ambiguity. This solution supports bi-directional traffic, including up-link and down-link communications transfers, between the mobile node and the home network, or LMA 113 during the handoff period. After the handoff procedure is complete and the mobile node has moved completely to connectivity with nMAG 155, the nMAG 155 sends a proxy binding update PBU message 450 to the LMA 113, which updates its connection entry tables to show the new connection of the mobile node 125 with the nMAG 155 for the future direction and receipt of down-link and up-link communications, respectively, with the nMAG 155. It should be noted that this same fast handoff protocol can be used to create and establish a tunnel between EUTRAN eHRPD components in a fast handoff protocol.

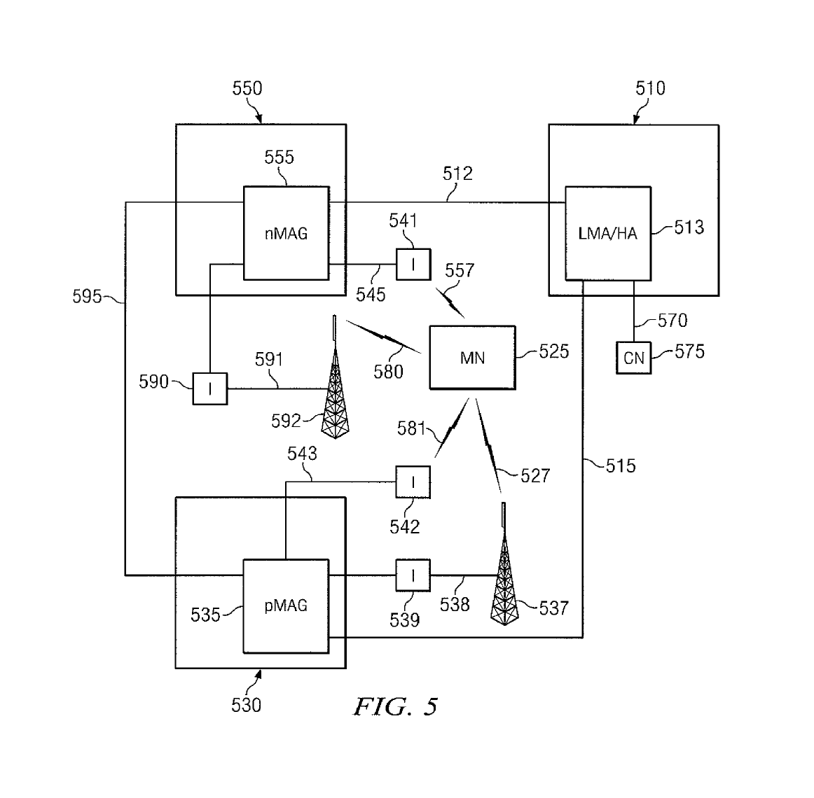

In FIG. 5, the overall architecture of the IP-based mobile system is shown with a mobile mode 525, a home network 510 and foreign networks 530 and 550, respectively. As shown in FIG. 5, the home network 510 has a home agent or local mobility anchor (LMA/HA) 513. The local mobility anchor (LMA/HA) 513 is coupled to a correspondent node 575 via communication link 570, the next mobility agent gateway (nMAG) 555 on a second foreign network 550 by communication link 512, and the prior mobility agent gateway (pMAG) 535 on a first foreign network 530 by communication link 515.

Prior to handoff of the mobile node connectivity to the system, the prior mobility agent gateway (pMAG) 535 on a first foreign network 530 is coupled to the mobile node 525 through the radio access system comprised of the base station transceiver 539 coupled to the antenna/transmitter 537 and a wireless communication link 527. The prior mobility agent gateway (pMAG) 535 can also be coupled the mobile node 525 using a second communication access type, such as WiMax or WiFi, which is supported by the interface 542 coupled to the pMAG 535 via connection 543 and coupled to the mobile node 525 via a wireless communication link 581.

After handoff of the mobile node connectivity to the system, the next mobility agent gateway (nMAG) 555 on a second foreign network 550 is coupled to the mobile node 525 through the radio access system comprised of the base station transceiver 590 coupled to the antenna/transmitter 592 and a wireless communication link 580. The next mobility agent gateway (nMAG) 555 can also be coupled the mobile node 525 using a second communication access type, such as WiMax or WiFi, which is supported by the interface 541 coupled to the nMAG 555 via connection 545 and coupled to the mobile node 525 via a wireless communication link 557.

Mobile node 525 is shown electronically coupled to the foreign networks 550 and 530 via the wireless communication links 527, 557, 580 and 581, respectively. The mobile node 525, however, can communicate with any transceiver or access network coupled to the foreign networks. That is, communications links 527 and 557 are radio transmitted links, but these links can be composed of any connection between two or more nodes on a network or users on networks or administrative domains.

The terms Local Mobility Anchor, home agent, and foreign agent may be as defined in the Mobile IP Protocol (RFC 2002), but these agents are not restricted to a single protocol or system. In fact, the term home agent, as used in this application, can refer to a home mobility manager, home location register, home serving entity, or any other agent at a home network 510 having the responsibility to manage mobility-related functionality for a mobile node 525. Likewise, the term mobility agent gateway, as used in this application, can refer to a foreign agent, serving mobility manager, visited location register, visiting serving entity, serving gateway, or any other agent on a foreign network having the responsibility to manage mobility-related functionality for a mobile node 525.

In the mobile IP communications system shown in FIG. 1, the mobile node 525 is identified by a permanent IP address. While the mobile node 525 is coupled to its home network 510, the mobile node 525 receives information packets like any other fixed node on the home network 510. When mobile, the mobile node 525 can also locate itself on foreign network, such as network 530 or 550. When located on foreign network 530 or 550, the home network 510 sends data communications to the mobile node 525 by “tunneling” the communications to the foreign network 530 or 550.

The mobile node 525 keeps the local mobility anchor 513 informed of its current location, or foreign network association, by registering a care-of address with the local mobility anchor 513. Essentially, the care-of address represents the foreign network where the mobile node 525 is currently located. If the local mobility anchor 513 receives an information packet addressed to the mobile node 525 while the mobile node 525 is located on a foreign network 530, the local mobility anchor 513 will “tunnel” the information packet to foreign network 530 for subsequent transmission to mobile node 525. If the local mobility anchor 513 receives an information packet addressed to the mobile node 525 while the mobile node 525 is located on a foreign network 550, the local mobility anchor 513 will “tunnel” the information packet to foreign network 550 for subsequent transmission to mobile node 525. The foreign agent 535 or 555 receives information packets for the mobile node 525 (depending on the mobile node's foreign network connection) after the information packets have been forwarded to the foreign agent 535 by the local mobility anchor 513. If the pMAG 535 also serves as a default router for in-coming information packets as well during the fast handover transition. These communications to the mobile node 525 are called “down-link” communications.

The foreign agent pMAG 535 serves as a default router for out-going information packets generated by the mobile node 525 while connected to the foreign network 530 and during a fast handoff transition. The mobile node 525 sends out-going transmissions to the foreign agent 535 or 555 (depending on the mobile node's foreign network connection), and the foreign agent sends the communications onto the local mobility anchor 513 for transmission onto other nodes, such as the correspondent node 575. These communication from the mobile node 525 are called “up-link” communications.

The LMA/HA 513 can be coupled to a larger service network, such as a 3GPP2 network. The foreign agent 535 or 555 (depending on the mobile node's foreign network connection) participates in informing the local mobility anchor 513 of the mobile node 525 current care-of address. Moreover, the mobile node 525 can also participate in informing the local mobility anchor 513 of its current location and requests connections to the associated foreign network. When the mobile node 525 transitions to connecting to a different access type on the foreign network or a wholly different foreign network (handover), the mobile node 525 obtains appropriate information regarding the address of the foreign network and/or the foreign agent from an agent advertisement.

Connection 595 is an inter-MAG tunnel connection in the IP-Layer between pMAG 535 and nMAG 555, where transfer of the mobility session context information for the mobile node to the next MAG in advance of the fast handoff to avoid delays and an inter-serving gateway uni-directional tunneling mechanism to allow forwarding of the mobility session traffic between new serving gateway and the prior serving gateway without ambiguity. This solution supports uni-directional traffic, including up-link or down-link communications transfers to the mobile node (but not both), between the mobile node and the home network, or LMA. Connection 595, the inter-MAG tunnel connection in the IP-Layer between pMAG 535 and nMAG 555, is where transfer of the mobility session context information for the mobile node to the next MAG in advance of the fast handoff to avoid delays and an inter-serving gateway uni-directional tunneling mechanism to allow forwarding of the mobility session traffic between new serving gateway and the prior serving gateway without ambiguity. It should be noted that the same fast handoff protocols set forth below can be used to create and establish a tunnel between EUTRAN eHRPD components in a fast handoff protocol.

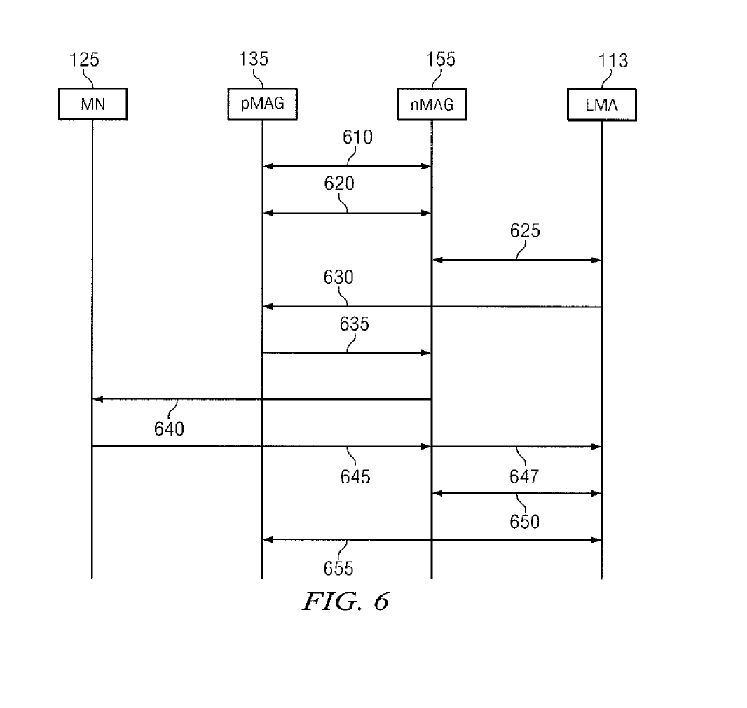

In FIG. 6, the dynamic inter-MAG bi-directional tunnel protocol or message flow is shown with reference to the components shown in FIG. 5. In the protocol defined in FIG. 6, a new tunneling type is established between the pMAG 535 and the nMAG 555 to carry information regarding the current per-mobility session uni-directional tunneling mechanism for use in the fast handoff signaling messages. This tunneling mechanism is used with an enhancement of PMIPv6 that allows the nMAG 555 to create a temporary forwarding state for the nMAG 555 to transfer up-link traffic from the mobile node directly to the LMA 513 during the fast handoff protocol. The down-link traffic is sent routed through the pMAG 535, which routes the traffic to the nMAG 555 and then to the mobile node 525 as a uni-lateral down-link traffic.

The tunnel between the pMAG 535 and the LMA 513 as negotiated and communicated down to the nMAG 555 using fast handover signaling messages. The negotiated tunneling type is communicated from the pMAG 535 to the nMAG 555 using the fast handoff signaling and may depend on handoff mode and reactive or active modes used to create the tunnel. The nMAG 555 send a Proxy Binding Update (PBU) message to the LMA 513 during the fast handover procedure to anchor the mobile node 525 mobility session for the LMA 513 and create a state that allows the LMA to accept up-link traffic from the nMAG 555 while maintaining a binding state for down-link to the mobile node 525 as sent through the pMAG 535.

The negotiated tunneling type is used to create the uni-directional IP-Layer tunnel between the pMAG 535 and nMAG 555 for down-link traffic. The GRE encapsulation/tunneling with Generic Routing Encapsulation (GRE) keys as the IP-Layer tunneling mechanism between the pMAG 535 and nMAG 555 may be supported. The PBU from the nMAG 555 is used for uplink traffic from the mobile node 525, and the nMAG 555 needs the mobile node ID, the LMA IP address and other information as part of the PBU message to the LMA 513. The PBU cannot be sent by the nMAG 555 until this information is made available to it, but this information can be sent in the HACK message from the pMAG 535. As soon as the nMAG 555 receives this information, it can sent the PBU and receive a Proxy Binding Acknowledge message PBA from the LMA 513, and as soon as it sends the PBU to the LMA 513, the nMAG 555 can start sending uplink communications to the LMA 513.

The inter-MAG tunnel option is transmitted between the pMAG 535 and the LMA 513, as used in the fast handoff signaling messages. The final tunneling type is defined in communications between the pMAG 535 and the nMAG 555. The Tunneling Type option is included as follows: (1) the pMAG 535 includes a tunneling type option and the tunnel type specific parameters in the HACK messages sent to the nMAG 555 in the reactive mode. The nMAG 555 creates a routing table entry on the inter-MAG interface which point to the mobile node with tunnel specific parameters, such as down-link GRE keys.

The nMAG 555 will start accepting and de-capsulating tunneled packets over the inter-MAG tunnel and forward these packets to the mobile node attached to the appropriate access network node (nAN). After the handoff procedure is complete and the mobile node has moved completely to connectivity with nMAG 555, the nMAG 555 sends a proxy binding update PBU to the LMA 513, which updates its connection entry tables to show the new connection of the mobile node 525 with the nMAG 555 for the future direction and receipt of down-link and up-link communications, respectively, with the nMAG 155. Alternatively, the nMAG 555 may send an update message to extend a temporary lifetime after a temporary state expires, which may be more efficient than making a static configurable lifetime period because the nMAG 555 can communicate to the pMAG 535 to delete the uni-direction IP-Layer tunnel.

To complete the handoff procedure, the pMAG 535 can send a de-registration message to the LMA 513 with a zero lifetime or the LMA can send a send BRI message to the pMAG 535. The LMA 513 updates its cache entry table if it receives a BRI message from the pMAG 535 to indicate that the mobile node 525 has moved. These messages will indicate to the pMAG 535 that the mobile node has moved, and the temporary state in the binding cache entry table can be avoided is to allow the nMAG 555 to send a PBU to the LMA 513, which will allow the LMA 513 to update its binding cache entry table to allow acceptance of up-link communication traffic from the nMAG 555 for the mobile node 525. These protocols can also be used with a pre-configured IP tunnel creation and maintenance described in FIGS. 2 and 3, above.

As shown in FIG. 6, step 610 shows a Reactive Mode negotiation of the dynamic bi-directional tunnel with the nMAG 555 sending a handover interface HI message to the pMAG 535, and the pMAG 535 sends a handover acknowledge HACK message back to nMAG 555, thereby exchanging the necessary key information and establishing the inter-MAG tunnel between the pMAG 535 and nMAG 555. The nMAG 155 should include the GRE keys if it initiates the fast handover protocols (reactive mode), and if the GRE encapsulation is not required or a different tunneling mechanism is used, the pMAG 535 should acknowledge the handoff interface HI message without including the GRE key option (reactive mode). The pMAG 535 can force the GRE encapsulation with GRE keys by acknowledging the handoff interface HI message with the GRE key option included.

Alternatively, in the Active Mode exchange of GRE keys shown in step 620, the pMAG 535 sends a handover interface HI message to the nMAG 555, and the nMAG 555 sends a handover acknowledge HACK message back to pMAG 535, thereby exchanging the needed GRE keys and establishing the inter-MAG tunnel between the pMAG 535 and nMAG 555. In the active mode, the pMAG 535 includes a tunneling type option in the handoff interface HI message and all the required for that tunneling type. For example the pMAG can include the User Data Protocol (UDP) port number for UDP type tunneling as part of the tunneling type option or the mobility session context. The pMAG 135 can include the GRE Key option with the down-link GRE key included to force the GRE encapsulation with GRE keys, which may be used in the situation where the nMAG 555 found dynamically via the fast handoff signaling that there is not Network Access Translation component between the nMAG 555 and the pMAG 535. In that event, the nMAG includes a GRE key option with the uplink GRE key in a successful HACK message.

After either step 610 or 620 occurs, the nMAG 555 transmits a PBU message to the LMA 513 and receives a PBA message from the LMA 513, the PBU/PBA exchange designated in step 625. This PBU messaging allows the LMA 513 to update its entry tables so that uplink traffic can be sent directly from the nMAG 555 to the LMA 513.

As for down-link traffic, the creation of the dynamic tunnel is done on a per-mobility session basis, the necessary key and context information is exchanged between the pMAG 535 and LMA 513, and the keys and tunnels are specific to the inter-MAG tunnel between the pMAG 535 and nMAG 555. Keys or tunneling other than GRE keys can be used to support the uni-directional down-link traffic.

For the protocol in FIG. 6, the down-link communications are transferred in step 630 from the LMA 513 to the pMAG 535, which transfers the down-link communications to the nMAG 555 over the inter-MAG tunnel 595 in step 635. The nMAG 555 then transfers the down-link communications to the mobile node 525 in step 640. For up-link communications, the mobile node 525 transfers communications to the nMAG 555 at step 645, which transfers the up-link communication packets to the LMA 513 in step 647.

This protocol supports the transfer of the mobility session context information for the mobile node to the next MAG in advance of the fast handoff to avoid delays and an inter-serving gateway uni-directional tunneling mechanism to allow forwarding of the mobility session traffic between new serving gateway and the prior serving gateway without ambiguity. This solution supports uni-directional traffic, including down-link communications transfers, between the LMA 513 to the mobile node 525, with the nMAG 555 sending up-link communication traffic directly to the home network, or LMA 113 during the handoff period.

After the handoff procedure is complete and the mobile node has moved completely to connectivity with nMAG 555, the nMAG 555 sends a proxy binding update PBU to the LMA 513 at step 650, which updates its connection entry tables to show the new connection of the mobile node 525 with the nMAG 555 for the future direction and receipt of down-link and up-link communications, respectively, with the nMAG 555. Alternatively, the nMAG 555 may send an update message at step 650 to the LMA 513 to extend a temporary lifetime after a temporary state expires, which may be more efficient than making a static configurable lifetime period because the nMAG 555 can communicate to the pMAG 535 to delete the uni-direction IP-Layer tunnel.

To complete the handoff procedure, the pMAG 535 can send a de-registration message to the LMA 513 at step 655 with a zero lifetime or the LMA can send a send BRI message to the pMAG 535 at step 655. The LMA 513 updates its cache entry table if it receives a BRI message from the pMAG 535 to indicate that the mobile node 525 has moved. These messages will indicate to the pMAG 535 that the mobile node has moved, and the temporary state in the binding cache entry table can be avoided is to allow the nMAG 555 to send a PBU to the LMA 513, which will allow the LMA 513 to update its binding cache entry table to allow acceptance of up-link communication traffic from the nMAG 555 for the mobile node 525.

In FIG. 6, the dynamic inter-MAG bi-directional tunnel protocol or message flow is shown with reference to the components shown in FIG. 5. In the protocol defined in FIG. 6, a new tunneling type is established between the pMAG 535 and the nMAG 555 to carry information regarding the current per-mobility session uni-directional tunneling mechanism for use in the fast handoff signaling messages. This tunneling mechanism is used with an enhancement of PMIPv6 that allows the nMAG 555 to create a temporary forwarding state for the nMAG 555 to transfer up-link traffic from the mobile node directly to the LMA 513 during the fast handoff protocol. The down-link traffic is sent routed through the pMAG 535, which routes the traffic to the nMAG 555 and then to the mobile node 525 as a uni-lateral down-link traffic.

The tunnel between the pMAG 535 and the LMA 513 as negotiated and communicated down to the nMAG 555 using fast handover signaling messages. The negotiated tunneling type is communicated from the pMAG 535 to the nMAG 555 using the fast handoff signaling and may depend on handoff mode and reactive or active modes used to create the tunnel. The nMAG 555 send a Proxy Binding Update (PBU) message to the LMA 513 during the fast handover procedure to anchor the mobile node 525 mobility session for the LMA 513 and create a state that allows the LMA to accept up-link traffic from the nMAG 555 while maintaining a binding state for down-link to the mobile node 525 as sent through the pMAG 535.

The negotiated tunneling type is used to create the uni-directional IP-Layer tunnel between the pMAG 535 and nMAG 555 for down-link traffic. The GRE encapsulation/tunneling with Generic Routing Encapsulation (GRE) keys as the IP-Layer tunneling mechanism between the pMAG 535 and nMAG 555 may be supported. The PBU from the nMAG 555 is used for uplink traffic from the mobile node 525, and the nMAG 555 needs the mobile node ID, the LMA IP address and other information as part of the PBU message to the LMA 513. The PBU cannot be sent by the nMAG 555 until this information is made available to it, but this information can be sent in the HACK message from the pMAG 535. As soon as the nMAG 555 receives this information, it can sent the PBU and receive a Proxy Binding Acknowledge message PBA from the LMA 513, and as soon as it sends the PBU to the LMA 513, the nMAG 555 can start sending uplink communications to the LMA 513.

The inter-MAG tunnel option is transmitted between the pMAG 535 and the LMA 513, as used in the fast handoff signaling messages. The final tunneling type is defined in communications between the pMAG 535 and the nMAG 555. The Tunneling Type option is included as follows: (1) the pMAG 535 includes a tunneling type option and the tunnel type specific parameters in the HACK messages sent to the nMAG 555 in the reactive mode. The nMAG 555 creates a routing table entry on the inter-MAG interface which point to the mobile node with tunnel specific parameters, such as down-link GRE keys.

The nMAG 555 will start accepting and de-capsulating tunneled packets over the inter-MAG tunnel and forward these packets to the mobile node attached to the appropriate access network node (nAN). After the handoff procedure is complete and the mobile node has moved completely to connectivity with nMAG 555, the nMAG 555 sends a proxy binding update PBU to the LMA 513, which updates its connection entry tables to show the new connection of the mobile node 525 with the nMAG 555 for the future direction and receipt of down-link and up-link communications, respectively, with the nMAG 155. Alternatively, the nMAG 555 may send an update message to extend a temporary lifetime after a temporary state expires, which may be more efficient than making a static configurable lifetime period because the nMAG 555 can communicate to the pMAG 535 to delete the uni-direction IP-Layer tunnel.

To complete the handoff procedure, the pMAG 535 can send a de-registration message to the LMA 513 with a zero lifetime or the LMA can send a send BRI message to the pMAG 535. The LMA 513 updates its cache entry table if it receives a BRI message from the pMAG 535 to indicate that the mobile node 525 has moved. These messages will indicate to the pMAG 535 that the mobile node has moved, and the temporary state in the binding cache entry table can be avoided is to allow the nMAG 555 to send a PBU to the LMA 513, which will allow the LMA 513 to update its binding cache entry table to allow acceptance of up-link communication traffic from the nMAG 555 for the mobile node 525. These protocols can also be used with a pre-configured IP tunnel creation and maintenance described in FIGS. 2 and 3, above.

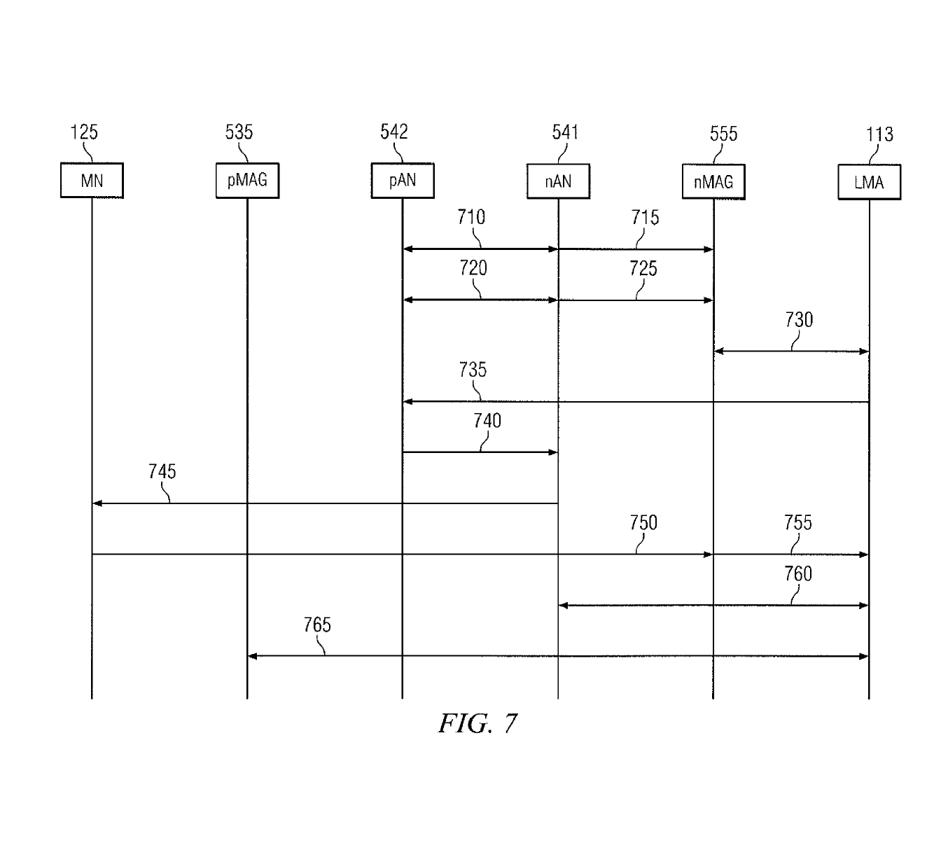

As shown in FIG. 7, step 710 shows a Reactive Mode negotiation of the dynamic tunnel with the access node nAN 541 or 590/592 sending a handover interface HI message to the pAN 542 or 539/537, which sends a handover acknowledge HACK message back to nAN 541 or 590/592, thereby exchanging the necessary key information and establishing the inter-aAN (Access Node) tunnel between the nAN 541 or 590/592 and the pAN 542 or 539/537. The pAN 542 or 539/537 should include the GRE keys if it initiates the fast handover protocols (reactive mode), and if the GRE encapsulation is not required or a different tunneling mechanism is used, the pAN 542 or 539/537 should acknowledge the handoff interface HI message without including the GRE key option (reactive mode). The pAN 542 or 539/537 can force the GRE encapsulation with GRE keys by acknowledging the handoff interface HI message with the GRE key option included.

Alternatively, in the Active Mode exchange of GRE keys shown in step 720, the pAN 542 or 539/537 sends a handover interface HI message to the nAN 541 or 590/592, and the nAN 541 or 590/592 sends a handover acknowledge HACK message back to pAN 542 or 539/537, thereby exchanging the needed GRE keys and establishing the inter-MAG tunnel between the pAN 542 or 539/537 and nAN 541 or 590/592. In the active mode, the pAN 542 or 539/537 includes a tunneling type option in the handoff interface HI message and all the required for that tunneling type. For example the pAN 542 or 539/537 can include the User Data Protocol (UDP) port number for UDP type tunneling as part of the tunneling type option or the mobility session context. The pAN 542 or 539/537 can include the GRE Key option with the down-link GRE key included to force the GRE encapsulation with GRE keys, which may be used in the situation where the 555 found dynamically via the fast handoff signaling that there is not Network Access Translation component between the nAN 541 or 590/592 and the pAN 542 or 539/537. In that event, the nMAG 555 includes a GRE key option with the uplink GRE key in a successful HACK message.

After either step 710 or 720 occurs, the nMAG 555 is notified by the nAN 541 of the mobile node handoff in steps 715 or 725, respectively. The nMAG 555 transmits a PBU message to the LMA 513 and receives a PBA message from the LMA 513, the PBU/PBA exchange designated in step 730. This PBU messaging allows the LMA 513 to update its entry tables so that uplink traffic can be sent directly from the nMAG 555 to the LMA 513.

As for down-link traffic, the creation of the dynamic tunnel is done on a per-mobility session basis, the necessary key and context information is exchanged between the pAN 542 or 539/537 and LMA 513, and the keys and tunnels are specific to the inter-MAG tunnel between the pAN 542 or 539/537 and nAN 541 or 590/592. Keys or tunneling other than GRE keys can be used to support the uni-directional down-link traffic.

For the protocol in FIG. 7, the down-link communications are transferred in step 735 from the LMA 513 to the pAN 542 or 539/537, which transfers the down-link communications to the nAN 541 or 590/592 over the inter-MAG tunnel 595 in step 740. The nAN 541 or 590/592 then transfers the down-link communications to the mobile node 525 in step 745. For up-link communications, the mobile node 525 transfers communications to the nMAG 555 at step 750, which transfers the up-link communication packets to the LMA 113 in step 755.

This protocol supports the transfer of the mobility session context information for the mobile node to the next AN in advance of the fast handoff to avoid delays and an inter-serving gateway uni-directional tunneling mechanism to allow forwarding of the mobility session traffic between new serving gateway and the prior serving gateway without ambiguity. This solution supports uni-directional traffic, including down-link communications transfers, between the LMA 513 to the mobile node 525, with the nMAG 555 sending up-link communication traffic directly to the home network, or LMA 113 during the handoff period.

After the handoff procedure is complete and the mobile node has moved completely to connectivity with nMAG 555, the nMAG 555 sends a proxy binding update PBU to the LMA 513 at step 760, which updates its connection entry tables to show the new connection of the mobile node 525 with the nMAG 555 and nAN 541 or 590/592 for the future direction and receipt of down-link and up-link communications, respectively, with the nMAG 555 and nAN 541 or 590/592. Alternatively, the nMAG 555 may send an update message at step 760 to the LMA 513 to extend a temporary lifetime after a temporary state expires, which may be more efficient than making a static configurable lifetime period because the nMAG 555 can communicate to the pMAG 535 to delete the uni-direction IP-Layer tunnel.

To complete the handoff procedure, the pMAG 535 can send a de-registration message to the LMA 513 at step 765 with a zero lifetime or the LMA can send a send BRI message to the pMAG 535 at step 765. The LMA 513 updates its cache entry table if it receives a BRI message from the pMAG 535 to indicate that the mobile node 525 has moved. These messages will indicate to the pMAG 535 that the mobile node has moved, and the temporary state in the binding cache entry table can be avoided is to allow the nMAG 555 to send a PBU to the LMA 513, which will allow the LMA 513 to update its binding cache entry table to allow acceptance of up-link communication traffic from the nMAG 555 for the mobile node 525.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention.

We claim:

1. A first mobile gateway for supporting communications with a mobile node during a handoff transition period when connectivity of the mobile node is transitioning from a first foreign network served by the first mobile gateway to a second foreign network served by a second mobile gateway, the first mobile gateway being configured:
to support communications between the mobile node and a home agent on a home network;
to transmit session context and key information to the second mobile gateway to establish a tunnel between the first mobile gateway and the second mobile gateway, the tunnel being created and maintained during the transition of connectivity; and
during the handoff transition period, to transmit downlink communications packets received from the home agent over the tunnel to the second mobile gateway for transmission to the mobile node.

2. The first mobile gateway of claim 1, wherein the tunnel is a bi-directional tunnel and the first mobile gateway is further configured, during the handoff transition period:
to receive, over the tunnel from the second mobile gateway, uplink packets that were transmitted by the mobile node; and
to transmit the uplink packets received from the second mobile gateway to the home agent.

3. The first mobile gateway of claim 1, wherein the tunnel is a uni-directional tunnel.

4. The first mobile gateway of claim 1, further configured to establish the tunnel between the first mobile gateway and the second mobile gateway based on pre-configured tunnel and message context information established with initiation of a communication session with the mobile node.

5. The first mobile gateway of claim 4, wherein the pre-configured tunnel and message context information comprises Generic Routing Encapsulation (GRE) keys.

6. The first mobile gateway of claim 1, further configured to establish the tunnel dynamically based on information exchanged between the first foreign network and the second foreign network.

7. The first mobile gateway of claim 6, further configured to establish the tunnel dynamically by negotiating a tunneling type with the second mobile gateway.

8. The first mobile gateway of claim 1, further configured:
to receive a handoff completion message from the second mobile gateway; and
to transmit the handoff completion message to the home agent to cancel an association of the mobile node with the first mobile gateway and to establish an association of the mobile node with the second mobile gateway.

9. The first mobile gateway of claim 8, wherein the handoff completion message is a proxy binding update message.

10. The first mobile gateway of claim 8, wherein the handoff completion message indicates that a temporary lifetime should be adjusted to make the new connection with the second foreign network non-transitional.

11. A second mobile gateway for supporting communications with a mobile node during a handoff transition period when connectivity of the mobile node is transitioning from a first foreign network served by a first mobile gateway to a second foreign network served by the second mobile gateway, the first mobile gateway supporting communications between the mobile node and a home agent on a home network, the second mobile gateway being configured:
to receive session context and key information from the first mobile gateway to establish a tunnel between the first mobile gateway and the second mobile gateway, the tunnel being created and maintained during the transition of connectivity; and
during the handoff transition period:
to receive, over the tunnel from the first mobile gateway, downlink packets that were transmitted by the home agent; and
to transmit the downlink packets received from the first mobile gateway to the mobile node.

12. The second mobile gateway of claim 11, wherein the tunnel is bi-directional and the second mobile gateway is further configured, during the handoff transition period, to transmit uplink communications packets received from the mobile node over the tunnel to the first mobile gateway for transmission to the home agent.

13. The second mobile gateway of claim 11, wherein the tunnel is a uni-directional tunnel, and the second mobile gateway is further configured, during the handoff transition period, to transmit uplink communications to the home agent using a temporary forwarding state.

14. The second mobile gateway of claim 13, wherein the temporary forwarding state is enabled by an enhancement to PMIPv6.

15. The second mobile gateway of claim 11, further configured to establish the tunnel between the first mobile gateway and the second mobile gateway based on pre-configured tunnel and message context information established with initiation of a communication session with the mobile node.

16. The second mobile gateway of claim 15, wherein the pre-configured tunnel and message context information comprises Generic Routing Encapsulation (GRE) keys.

17. The second mobile gateway of claim 11, further configured to establish the tunnel dynamically based on information exchanged between the first foreign network and the second foreign network.

18. The second mobile gateway of claim 17, further configured to establish the tunnel dynamically by negotiating a tunneling type with the first mobile gateway.

19. The second mobile gateway of claim 11, further configured to transmit a handoff completion message to the home agent on the home network to cancel an association of the mobile node with the first mobile gateway on the first foreign network and to establish an association of the mobile node with the second mobile gateway.

20. The second mobile gateway of claim 19, wherein the handoff completion message is a proxy binding update message.

21. The second mobile gateway of claim 19, wherein the handoff completion message indicates that a temporary lifetime should be adjusted to make the new connection with the second foreign network non-transitional.
